(19) United States
(12) Patent Application Publication
(10) Pub. No.: US 2013/0286042 A1
(43) Pub. Date: Oct. 31, 2013

(54) TILE ICON DISPLAY

(71) Applicant: Akihiko Ikeda, Taipei (TW)

(72) Inventor: Akihiko Ikeda, Taipei (TW)

(21) Appl. No.: 13/456,848

(22) Filed: Apr. 26, 2012

(51) Int. Cl. G06F 3/041; G09G 5/00

(52) U.S. Cl. 345/619

(57) ABSTRACT

A system for tile icon display can retrieve a first number of unique identifiers from a first file system directory, retrieving a second number of unique identifiers from a second file system directory, displaying a first number of tile icons in a first portion of a display grid of a touch screen, wherein each of the first number of tile icons is respectively associated with one of the first number of unique identifiers, and displaying a second number of tile icons in a second portion of the display grid of the touch screen, wherein each of the second number of tile icons is respectively associated with one of the second number of unique identifiers.

### BACKGROUND

Some electronic devices can be controlled by a keypad. However, other electronic devices include a touch-screen to provide users a convenient way to control the electronic devices. A touch-screen device includes a touch-screen. A touch-screen is an electronic visual output displayed on a display area of the touch-screen device. The touch-screen can detect the presence and location of a touch within the display area.

Although touch-screen devices may be convenient, using touch-screen devices can increase the number of errors that a user incurs when using the touch-screen device. The errors can be caused, in part, by small targets, location of the targets, and appearance of the targets, among other factors.

### BRIEF DESCRIPTION OF THE DRAWINGS

FIG. 1 is a flow chart illustrating an example of a method tile icon display.

FIG. 2 illustrates a block diagram of an example of a computer-readable medium in communication with processing resources for determining root cause according to the present disclosure.

FIG. 3A illustrates a block diagram of an example of a system for tile icon display according to the present disclosure.

FIG. 3B illustrates a block diagram of a portion of the example of the system illustrated in FIG. 3A.

FIG. 3C illustrates a block diagram of a portion of the example of the system illustrated in FIG. 3A.

### DETAILED DESCRIPTION

Examples of the present disclosure include methods, systems, and computer-readable media with executable instructions stored thereon for tile icon display. As an example, a method for tile icon display can include retrieving a first number of unique identifiers from a first file system directory, retrieving a second number of unique identifiers from a second file system directory, displaying a first number of tile icons in a first portion of a display grid of a touch screen, wherein each of the first number of tile icons is respectively associated with one of the first number of unique identifiers, and displaying a second number of tile icons in a second portion of the display grid of the touch screen, wherein each of the second number of tile icons is respectively associated with one of the second number of unique identifiers. In one example, the first portion of the display grid includes a top half area or portion of the display device and the second portion of the display grid includes a bottom half or portion of the display device. In another example, the first portion of the display grid includes a first side half area or portion of the display device and the second portion of the display grid includes a second side half or portion of the display device.

Some operating systems are not configured to retrieve unique identifier from a file system directories and display tile icons in a display grid of a touch screen, wherein each of the of tile icons is respectively associated with one of unique identifiers. As such users employing these operating systems and a touch screen may find it difficult to launch items in the file system directories. Advantageously, examples of the present disclosure may help users to utilize a touch screen coupled to a operating system by retrieving a first number of unique identifiers from a first file system directory, retrieving a second number of unique identifiers from a second file system directory, displaying a first number of tile icons in a first portion of a display grid of a touch screen, wherein each of the first number of tile icons is respectively associated with one of the first number of unique identifiers, and displaying a second number of tile icons in a second portion of the display grid of the touch screen, wherein each of the second number of tile icons is respectively associated with one of the second number of unique identifiers.

In the present disclosure, reference is made to the accompanying drawings that form a part hereof, and in which is shown by way of illustration how one or more examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

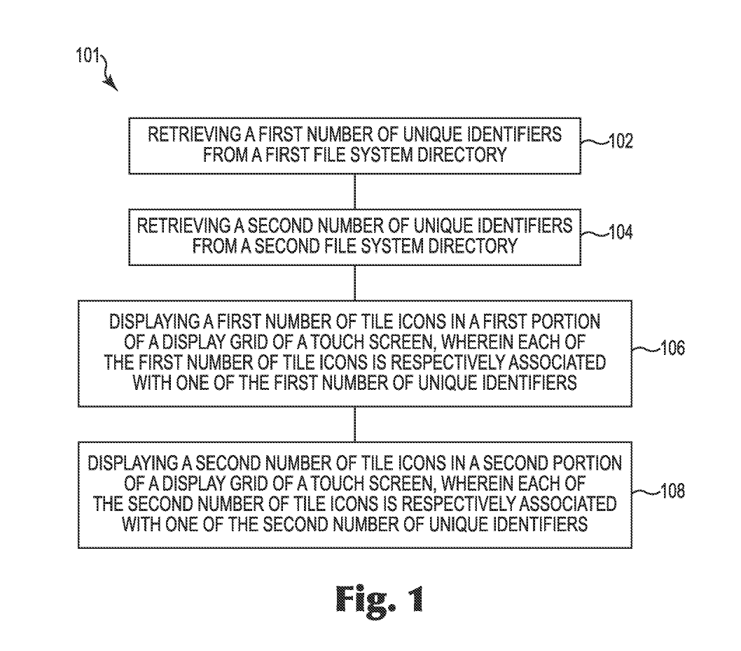

FIG. 1 is a flow chart illustrating an example of a method 101 for tile icon display. The method 101 includes retrieving a first number of unique identifiers from a first file system directory at 102. Examples of the present disclosure provide that the first number can have a value that is equal to a number of unique identifiers located in the first file system directory. However, examples are not so limited. For instance, examples of the present disclosure provide that the first number can have a value that is less than a number of unique identifiers located in the first file system directory.

Unique identifiers can be used to identify a particular object or a process, for example. Unique identifiers can include values, such as numeric values, text values, and//or other types of values. Examples of unique identifiers include, but are not limited to, CSIDL (constant special item ID list) values and KNOWNFOLDERID values, among other unique identifiers.

A file system directory can be a repository for unique identifiers. Some examples of the present disclosure provide that the first file system directory is a desktop directory. As an example, first file system directory can be a folder such as CSIDL_COMMON_DESKTOPDIRECTORY and/or CSIDL_DESKTOPDIRECTORY. As an example, these file system directories can each respectively have a path C:\Users\Public\Desktop and C:\Users\username\Desktop.

The method 101 includes retrieving a second number of unique identifiers from a second file system directory at 104. Examples of the present disclosure provide that the second number can have a value that is equal to a number of unique identifiers located in the second file system directory. However, examples are not so limited. For instance, examples of the present disclosure provide that the second number can have a value that is less than a number of unique identifiers located in the second file system directory.

Some examples of the present disclosure provide that the second file system directory is a program directory. As an example, second file system directory can be a folder such as CSIDL_COMMON_PROGRAMS and/or CSIDL_PROGRAMS. As an example, these file system directories can each respectively have a path C:\ProgramData\Microsoft\Windows\Start Menu\Programs and C:\Users\username\AppData\Roaming\Microsoft\Windows\Start Menu\Programs.

The method 101 includes displaying a first number of tile icons in a first portion of a display grid of a touch screen, wherein each of the first number of tile icons is respectively associated with one of the first number of unique identifiers at 106. Each tile icon can be associated with a respective active area of the touch screen that responds to a touch from a user. The response from the touch of user can provide a particular command and/or information to the touch screen, an operating system coupled to the touch screen, and/or the user. Examples of the present disclosure provide that the tile icons can be text, a graphic, or a combination thereof. Some examples of the present disclosure provide that there is a tile icon for each unique identifier associated with the first file system directory. All or a portion of these tile icons can be displayed in the first portion of a display grid of touch screen at a particular instance. Tile icons not displayed at the particular instance can be displayed at a subsequent particular instance.

The touch screen can utilize a touch screen technology. Examples of the touch screen technology include, but are not limited to, resistive technology, surface acoustic wave technology, capacitive technology, infrared technology, strain gauge technology, optical imaging technology, dispersive signal technology, acoustic pulse recognition technology, frustrated total internal reflection technology, diffused laser imaging technology, and combinations thereof. Examples of the present disclosure provide that the touch screen can include, a liquid crystal display (LCD), a plasma display panel (PDP), a light emitting diode (LED), organic light emitting diode (OLED) among others.

The display grid is discussed further herein. The display grid can include a selection menu having a number of selection, such as a desktop selection icon, a start menu selection icon, and a both selection icon. Selecting, e.g., touching, the desktop selection icon can display only tile icons that are each respectively associated with one of the first number of unique identifiers. Selecting, e.g., touching, the start menu selection icon can display only tile icons that are each respectively associated with one of the second number of unique identifiers. Selecting, e.g., touching, the both selection icon can display tile icons that are each respectively associated with one of the first number of unique identifiers, and to display tile icons that are each respectively associated with one of the second number of unique identifiers.

The method 101 includes displaying a second number of tile icons in a second portion of the display grid of the touch screen, wherein each of the second number of tile icons is respectively associated with one of the second number of unique identifiers at 108. Some examples of the present disclosure provide that there is a tile icon for each unique identifier associated with the second file system directory. All or a portion of these tile icons can be displayed in the second portion of a display grid of touch screen at a particular instance. Tile icons not displayed at the particular instance can be displayed at a subsequent particular instance.

The touch screen is discussed further herein.

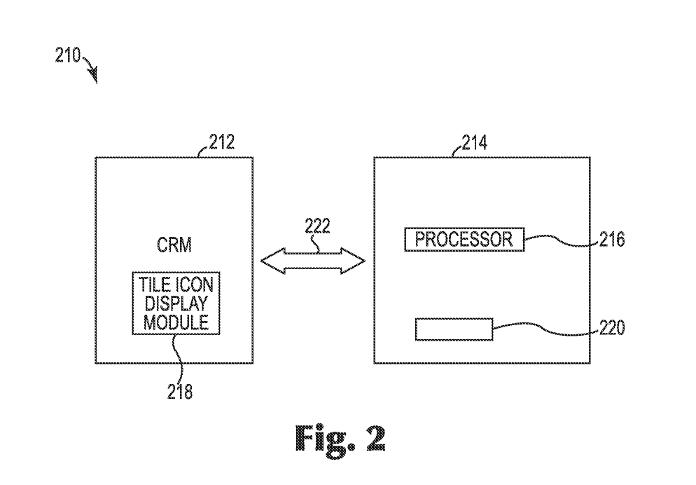

FIG. 2 illustrates a block diagram 210 of an example of a computer-readable medium 212 in communication with processing resources 216 for tile icon display according to the present disclosure. Computer-readable medium (CRM) 212 can be in communication with a computing device 214 having processor resource 216 that can be in communication with, and/or receive a tangible non-transitory CRM 212 including a tile icon display module 218 for tile icon display as described herein. Processing resource 216 can include one or a plurality of processors such as in a parallel processing system. The computing device 214 may include memory resources 220, and the processor resource 216 may be coupled to the memory resources 220.

The tile icon display module 218 can include computer-readable instructions for tile icon display and can be executed by processor resource 216. Computer-readable instructions can be stored on an internal or external non-transitory CRM 212. A non-transitory CRM (e.g., 212), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital video discs (DVD), Blu-ray discs (BD), compact discs (CD), and/or a solid state drive (SSD), flash memory, etc., as well as other types of CRM.

The non-transitory CRM 212 can be integral, or communicatively coupled, to a computing device, in either in a wired or wireless manner. For example, the non-transitory CRM can be an internal memory, a portable memory, a portable disk, or a memory located internal to another computing resource (e.g., enabling the computer-readable instructions to be downloaded over the Internet).

The CRM 212 can be in communication with the processor resource 216 via a communication path 222. The communication path 222 can be local or remote to a machine associated with the processor resource 216. Examples of a local communication path 222 can include an electronic bus internal to a machine such as a computer where the CRM 212 is one of volatile, non-volatile, fixed, and/or removable storage medium in communication with the processor resource 216 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 222 can be such that the CRM 212 is remote from the processor resource 216 such as in the example of a network connection between the CRM 212 and the processor resource 216. That is, the communication path 222 can be a network connection. Examples of such a network connection can include a local area network (LAN), a wide area network (WAN), a personal area network (PAN), and the Internet, among others. In such examples, the CRM 212 may be associated with a first computing device and the processor resource 216 may be associated with a second computing device.

The tile icon display module 218, e.g., the computer-readable instructions for tile icon display can be executed by the processor resource, to retrieve a first number of unique identifiers from a first file system directory. The tile icon display module 218 can retrieve a second number of unique identifiers from a second file system directory. The tile icon display module 218 can display a first number of tile icons in a first portion of a display grid of a touch screen, wherein each of the first number of tile icons is respectively associated with one of the first number of unique identifiers. The tile icon display module 218 can display a second number of tile icons in a second portion of the display grid of the touch screen, wherein each of the second number of tile icons is respectively associated with one of the second number of unique identifiers. Additionally, the tile icon display module 218 can display another number of tile icons, such as a third number of tile icons and/or a fourth third number of tile icons, as discussed further herein. Additionally, the tile icon display module 218 can remove a number of tile icons from display grid of the touch screen. For example, the tile icon display module 218 can remove at least one of the first number of tile icons from the first portion of the display grid of the touch screen and/or remove at least one of the second number of tile icons from the second portion of the display grid of the touch screen, as discussed further herein.

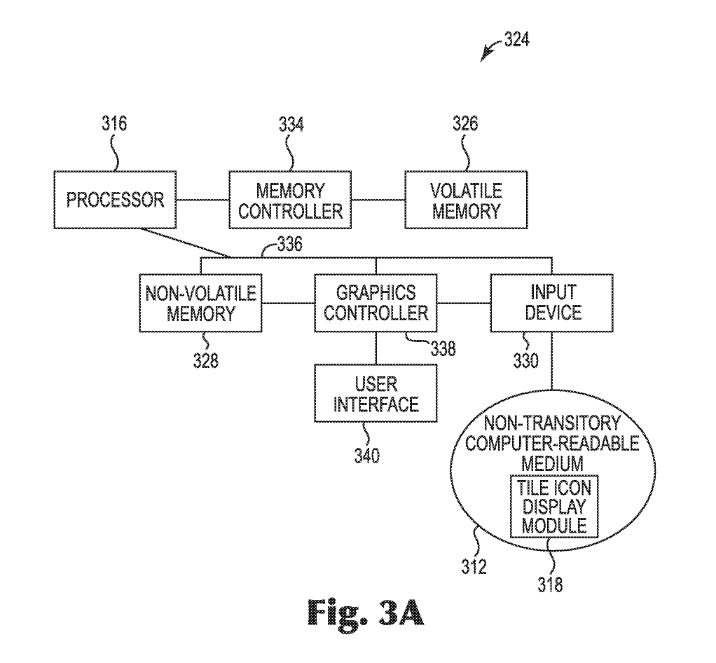

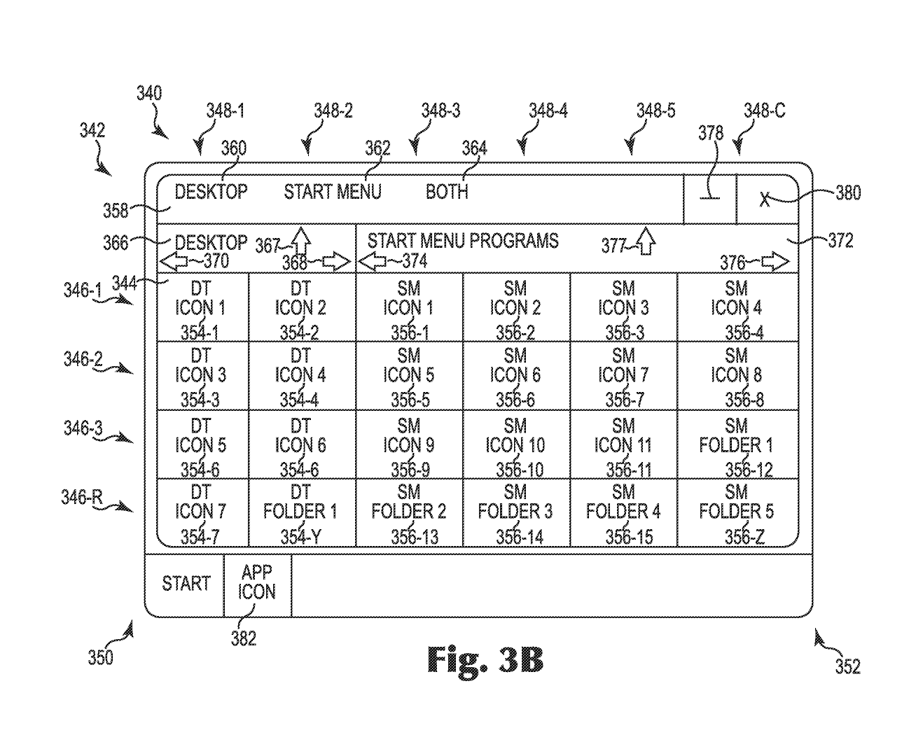

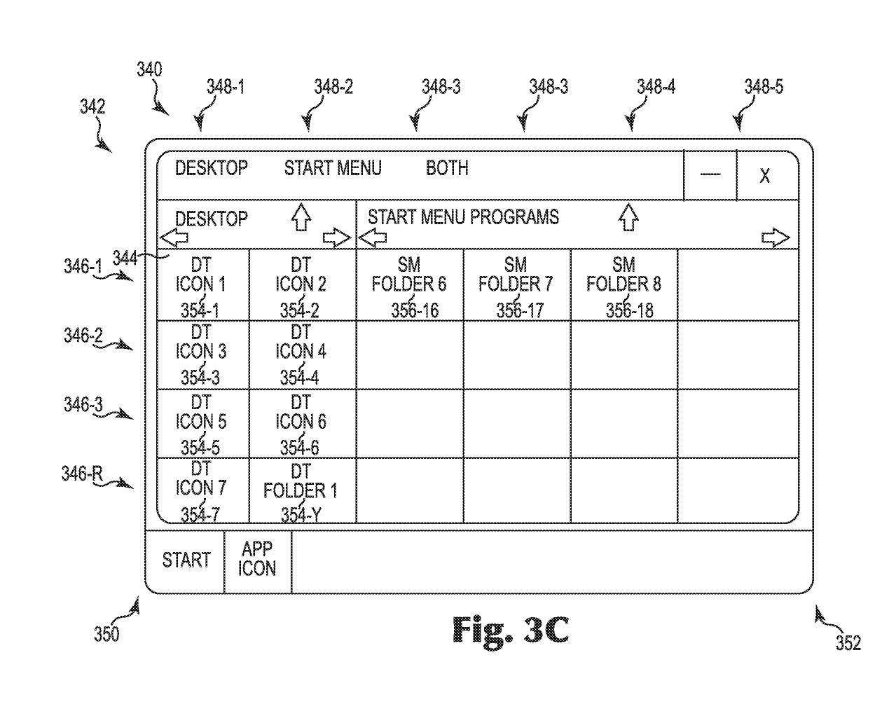

FIG. 3A illustrates a block diagram of an example of a portion of a system 324 for tile icon display according to the present disclosure. However, examples of the present disclosure are not limited to a particular system configuration. The system 324 can include processor resources 316 and memory resources, e.g., volatile memory 326 and/or non-volatile memory 328, for executing instructions stored in a tangible non-transitory medium, e.g., volatile memory 326, non-volatile memory 328, and/or computer-readable medium 312, and/or an application specific integrated circuit (ASIC) including logic configured to perform various examples of the present disclosure. The system 324 can include and/or receive a tangible non-transitory computer-readable medium 312 storing a set of computer -readable instructions 332, e.g., software, via an input device 330. As used herein, processor resources 316 can include one or a plurality of processors such as in a parallel processing system, Memory resources can include memory addressable by the processor resources 316 for execution of computer-readable instructions. The computer-readable medium 312 can include volatile and/or non-volatile memory such as random access memory (RAM), magnetic memory such as a hard disk, floppy disk, and/or tape memory, a solid state drive (SSD), flash memory, phase change memory, etc. In some examples, the non-volatile memory 328 can be a database including a plurality of physical non-volatile memory devices. In various examples, the database can be local to a particular system or remote, e.g., including a plurality of non-volatile memory devices 328. A computing device having processor resources can be in communication with, and/or receive a tangible non-transitory computer-readable medium can include a tile icon display module 318 storing a set of computer-readable instructions, e.g., software, that can be executed by the processing resources for tile icon display, as described herein.

The processor resources 316 can control the overall operation of the system 324. The processor resources 316 can be connected to a memory controller 334, which can read and/or write data from and/or to the memory, e.g., RAM. The memory controller 334 can include an ASIC and/or a processor with its own memory resources, e.g., volatile and/or non-volatile memory. The memory can include one or a plurality of memory modules, e.g., chips.

The processor resources 316 can be connected to a bus 336 to provide for communication between the processor resources 316, and other portions of the system 324. A graphics controller 338 can connect to a user interface 340, which can provide an image to a user based on activities performed by the system 324. Examples of the present disclosure provide that the user interface 340 includes a touch screen as discussed further herein. Some examples of the present disclosure provide that the particular set of instructions discussed herein can be executed in response to a user accessing a transition icon that is visible on the user interface 340. For example, the user can access the transition icon to transition the user interface 340 to the touch screen, e.g., from another type of input, such as keyboard input and/or mouse input.

In an example, the system 324 can provide for tile icon display, as discussed herein. For example, tile icon display module 318 including the particular set of instructions can be executed by the processing resource 316 to retrieve a first number of unique identifiers from a first file system directory. The instructions can be executed to retrieve a second number of unique identifiers from a second file system directory. The instructions can be executed to display a first number of tile icons in a first portion of a display grid of a touch screen 340, e.g. a touch screen that is coupled to an operating system, wherein each of the first number of tile icons is respectively associated with one of the first number of unique identifiers. The operating system can be Windows, Linux, Ubento, Android, or another other operating system with a graphical user interface. The instructions can be executed to display a second number of tile icons in a second portion of the display grid of the touch screen 340, wherein each of the second number of tile icons is respectively associated with one of the second number of unique identifiers. The instructions can be executed to remove at least one of the second number of tile icons from the second portion of the display grid of the touch screen 340. The instructions can be executed to display a third number of tile icons in the first portion of the display grid of the touch screen 340, wherein each of the third number of tile icons is respectively associated with one of the first number of unique identifiers.

FIG. 3B illustrates a block diagram of a portion of the example of the system illustrated in FIG. 3A. As illustrated in FIG. 3B, the user interface 340 includes a touch screen 342, as discussed herein.

Some examples of the present disclosure provide that the touch screen 342 can include a display grid 344. The display grid 344 can include a number of rows 346-1, 346-2, 346-3, . . . , 346-R, where R is an integer. The display grid 344 can include a number of columns 348-1, 348-2, 348-3, 348-4, 348-5 . . . , 346-C, where C is an integer. The integer R and the integer C can each have differing values for various applications.

As illustrated in FIG. 3B, the display grid 344 can include a first portion 350. In the example illustrated in FIG. 3B, the first portion 350 includes rows 346-1, 346-2, 346-3, and 346-R, e.g., where R has a value of 4, and columns 348-1 and 348-2. However, the first portion 350 can include differing numbers of rows and/or differing numbers of columns.

As illustrated in FIG. 3B, the display grid 344 can include a second portion 352. In the example illustrated in FIG. 3B, the second portion 352 includes rows 346-1, 346-2, 346-3, and 346-R, e.g., where R has a value of 4, and columns 348-3, 348-4, 348-5, and 348-C, e.g., where C has a value of 6. However, the second portion 352 can include differing numbers of rows and/or differing numbers of columns.

Each of the rows of the display grid 344 can have a height from 20 pixels to 144 pixels. Each of the columns of the display grid 344 can have a length from 20 pixels to 144 pixels. As such, each tile icon can have a size from 20 pixels×144 pixels to 144 pixels×20 pixels. Some examples of the present disclosure provide that the display grid 344 operates to fill an entire display area of the touch screen 342. For example, the first portion of the display grid and the second portion of the display grid can each occupy a respective space of the touch screen 342 according to predefined sizing.

Some examples of the present disclosure provide that the first portion 350 of the display grid 344 can display a first number of tile icons 354-1, 354-2, 354-3, 354-4, 354-5, 354-6, 354-7, . . . 354-Y, where Y is an integer. As illustrated in FIG. 3B, each of the first number of tile icons 354-1, 354-2, 354-3, 354-4, 354-5, 354-6, 354-7, . . . 354-Y is displayed in a respective cell defined by the intersection of a particular row and a particular column. As discussed herein, each of the first number of tile icons 354-1, 354-2, 354-3, 354-4, 354-5, 354-6, 354-7, . . . 354-Y is respectively associated with one of the first number of unique identifiers.

As illustrated in FIG. 3B, some examples of the present disclosure provide that the first portion 350 can begin at the first column 348-1. However, examples of the present disclosure are not so limited. For instance, for some examples of the present disclosure the first portion 350 can begin at the third column 348-3, the fourth column 348-4, or another column.

Some examples of the present disclosure provide that the second portion 352 of the display grid 344 can display a second number of tile icons 356-1, 356-2, 356-3, 356-4, 356-5, 356-6, 356-7, 356-8, 356-9, 356-10, 356-11, 356-12, 356-13, 356-14, 356-15, . . . 354-Z, where Z is an integer. As illustrated in FIG. 3B, each of the second number of tile icons 356-1, 356-2, 356-3, 356-4, 356-5, 356-6, 356-7, 356-8, 356-9, 356-10, 356-11, 356-12, 356-13, 356-14, 356-15, . . . 354-Z is displayed in a respective cell defined by the intersection of a particular row and a particular column. As discussed herein, each of the second number of tile icons 356-1, 356-2, 356-3, 356-4, 356-5, 356-6, 356-7, 356-8, 356-9, 356-10, 356-11, 356-12, 356-13, 356-14, 356-15, . . . 354-Z is respectively associated with one of the first number of unique identifiers.

As illustrated in FIG. 3B, some examples of the present disclosure provide that the second portion 352 can begin at the third column 348-3. However, examples of the present disclosure are not so limited. For instance, for some examples of the present disclosure the second portion 352 can begin at the first column 348-1 or another column.

Some examples of the present disclosure provide that the display grid 344 can include a selection menu 358. The selection menu 358 can include a number of selection icons. For example, the selection menu can include a desktop selection icon 360, a start menu selection icon 362, and a both selection icon 364. Selecting, e.g., touching, the desktop selection icon 360 can cause the touch screen to display only tile icons that are each respectively associated with one of the first number of unique identifiers, e.g., tile icons 354-1, 354-2, 354-3, 354-4, 354-5, 354-6, 354-7, . . . 354-Y. Selecting, e.g., touching, the start menu selection icon 362 can cause the touch screen to display only tile icons that are each respectively associated with one of the second number of unique identifiers, e.g., tile icons 356-1, 356-2, 356-3, 356-4, 356-5, 356-6, 356-7, 356-8, 356-9, 356-10, 356-11, 356-12, 356-13, 356-14, 356-15, . . . 354-Z. Selecting, e.g., touching, the both selection icon 364 can cause the touch screen to display tile icons that are each respectively associated with one of the first number of unique identifiers, and to display tile icons that are each respectively associated with one of the second number of unique identifiers e.g., tile icons 354-1, 354-2, 354-3, 354-4, 354-5, 354-6, 354-7, . . . 354-Y and tile icons 356-1, 356-2, 356-3, 356-4, 356-5, 356-6, 356-7, 356-8, 356-9, 356-10, 356-11, 356-12, 356-13, 356-14, 356-15, . . . 354-Z, as illustrated in FIG. 3B.

Some examples of the present disclosure provide that the display grid 344 can include a desktop navigation menu 366. The desktop navigation menu 366 can include an additional desktop tile icon button 368. Selecting, e.g., touching, the additional desktop tile icon button 368 can cause other tile icons to be displayed. For example, selecting the additional desktop tile icon button 368 can display a third number of tile icons in the first portion 350 of the display grid 344 of the touch screen 342, wherein each of the third number of tile icons is respectively associated with one of the first number of unique identifiers. Because the third number of tile icons is displayed, a number of the first number of tile icons is removed from the first portion 350 of the display grid 344 of the touch screen 342, e.g., to allow for display of the third number. However, examples are not so limited. For instance, some examples of the present disclosure provide that touching, e.g., sliding a finger from right to left, on the first portion 350 of the display grid 344 cause other tile icons to be displayed.

The desktop navigation menu 366 can include a previous desktop tile icon button 370. Selecting, e.g., touching, the previous desktop tile icon button 370 can cause tile icons that have been displayed previously to be displayed again. For example, selecting the previous desktop tile icon button 370 can display the first number of tile icons in the first portion 350 of the display grid 344 of the touch screen 342, wherein each of the first number of tile icons is respectively associated with one of the first number of unique identifiers and was previously displayed in the first portion 350 of the display grid 344. Because the first number of tile icons is displayed again, a number of the third number of tile icons is removed from the first portion 350 of the display grid 344 of the touch screen 342. However, examples are not so limited. For instance, some examples of the present disclosure provide that touching, e.g., sliding a finger from left to right, on the first portion 350 of the display grid 344 cause tile icons that have been displayed previously to be displayed again.

The desktop navigation menu 366 can include a close desktop folder button 367. Selecting, e.g., touching, the close desktop folder button 367 can cause tile icons that have been displayed previously to be displayed again. For example, if the first number of tile icons 354-1, 354-2, 354-3, 354-4, 354-5, 354-6, 354-7, . . . 354-Y are displayed in the first portion 350 of the display grid 344 and the tile icon 354-Y, which is associated with a desk top folder and is labeled as “DT Folder 1” in FIG. 3B, is selected then a third number of tile icons corresponding to unique identifiers associated with “DT Folder 1” can be displayed in the first portion 350 of the display grid 344. Thereafter, selecting the close desktop folder button 367 can remove the third number of tile icons and once again display the first number of tile icons. Additionally, while the third number of tile icons is displayed in the first portion 350 of the display grid 344, the additional desktop tile icon button 368 and/or the previous desktop tile icon button 370 may be utilized to display additional desktop tile icons, e.g. additional desktop tile icons corresponding to other unique identifiers associated with “DT Folder 1”. However, examples are not so limited. For instance, some examples of the present disclosure provide that touching, e.g., sliding a finger from up to down, on the first portion 350 of the display grid 344 cause tile icons that have been displayed previously to be displayed again.

Some examples of the present disclosure provide that the display grid 344 can include a start menu navigation menu 372. The start menu navigation menu 372 can include an additional start menu tile icon button 376. Selecting, e.g., touching, the additional start menu tile icon button 376 can cause other tile icons to be displayed. For example, selecting the additional start menu tile icon button 376 can display a fourth number of tile icons in the second portion 352 of the display grid 344 of the touch screen 342, wherein each of the fourth number of tile icons is respectively associated with one of the second number of unique identifiers. Because the fourth number of tile icons is displayed, a number of the second number of tile icons is removed from the second portion 352 of the display grid 344 of the touch screen 342, e.g., to allow for display of the fourth number. However, examples are not so limited. For instance, some examples of the present disclosure provide that touching, e.g., sliding a finger from right to left, on the second portion 352 of the display grid 344 can cause other tile icons to be displayed.

The start menu navigation menu 372 can include a previous start menu tile icon button 374. Selecting, e.g., touching, the previous start menu tile icon button 374 can cause tile icons that have been displayed previously to be displayed again. For example, selecting the previous start menu tile icon button 374 can display the second number of tile icons in the second portion 352 of the display grid 344 of the touch screen 342, wherein each of the second number of tile icons is respectively associated with one of the second number of unique identifiers and was previously displayed in the second portion 352 of the display grid 344. Because the second number of tile icons is displayed again, a number of the fourth number of tile icons is removed from the second portion 352 of the display grid 344 of the touch screen 342. However, examples are not so limited. For instance, some examples of the present disclosure provide that touching, e.g., sliding a finger from left to right, on the second portion 352 of the display grid 344 can cause tile icons that have been displayed previously to be displayed again.

The start menu navigation menu 372 can include a close start menu folder button 377. Selecting, e.g., touching, the close start menu folder button 377 can cause tile icons that have been displayed previously to be displayed again. For example, if the second number of tile icons 356-1, 356-2, 356-3, 356-4, 356-5, 356-6, 356-7, 356-8, 356-9, 356-10, 356-11, 356-12, 356-13, 356-14, 356-15, . . . 354-Z are displayed in the second portion 352 of the display grid 344 and the tile icon 356-Z, which is associated with a start menu folder and is labeled as “SM Folder 5” in FIG. 3B, is selected then a fourth number of tile icons corresponding to unique identifiers associated with “SM Folder 5” can be displayed in the second portion 352 of the display grid 344. Thereafter, selecting the close start menu folder button 377 can remove the fourth number of tile icons and once again display the second number of tile icons. Additionally, while the fourth number of tile icons is displayed in the second portion 352 of the display grid 344, the additional start menu tile icon button 374 and/or the previous start menu tile icon button 376 may be utilized to display additional start menu tile icons, e.g. additional start menu tile icons corresponding to other unique identifiers associated with “SM Folder 5”. However, examples are not so limited. For instance, some examples of the present disclosure provide that touching, e.g., sliding a finger from up to down, on the second portion 352 of the display grid 344 can cause tile icons that have been displayed previously to be displayed again.

Some examples of the present disclosure provide that the display grid 344 can include a minimize button 378. Selecting, e.g., touching, the minimize button 378 can cause the display grid 344 to be minimized, e.g., decreased into a restore icon. Some examples of the present disclosure provide that the display grid 344 can include a close button 380. Selecting, e.g., touching, the close button 380 can cause the display grid 344 to close. Some examples of the present disclosure provide that the display grid 344 can be opened by an application icon 382. Selecting, e.g., touching, the application icon 382 can cause the display grid 344 to open, e.g., retrieve the first number of unique identifiers from the first file system directory, retrieve the second number of unique identifiers from the second file system directory, display the first number of tile icons 354-1, 354-2, 354-3, 354-4, 354-5, 354-6, 354-7, . . . 354-Y in the first portion 350 of the display grid 344 of the touch screen 342, wherein each of the first number of tile icons 354-1, 354-2, 354-3, 354-4, 354-5, 354-6, 354-7, . . . 354-Y is respectively associated with one of the first number of unique identifiers, and display the second number of tile icons 356-1, 356-2, 356-3, 356-4, 356-5, 356-6, 356-7, 356-8, 356-9, 356-10, 356-11, 356-12, 356-13, 356-14, 356-15, . . . 354-Z in the second portion 352 of the display grid 344 of the touch screen 342, wherein each of the second number of tile icons 356-1, 356-2, 356-3, 356-4, 356-5, 356-6, 356-7, 356-8, 356-9, 356-10, 356-11, 356-12, 356-13, 356-14, 356-15, . . . 354-Z is respectively associated with one of the second number of unique identifiers.

As discussed, the first portion 350 of the display grid 344 and the second portion 352 of the display grid 344 can each occupy a respective space of the touch screen 342 according to predefined sizing. Some examples of the present disclosure provide that the third number of tile icons in the first portion 350 can be displayed in an area of the display grid 344 that is equal to an area that displays the first number of tile icons in the first portion 350. Likewise, some examples of the present disclosure provide that the fourth number of tile icons in the second portion 352 can be displayed in an area of the display grid 344 that is equal to an area that displays the second number of tile icons in the second portion 352. While the first number of tile icons, the second number of tile icons, the third number of tile icons, and the fourth number of tile icons are discussed herein, examples of the present disclosure are not so limited. For example, additional numbers of tile icons can be associated with the first file system directory and/or additional numbers of tile icons can be associated with the second file system directory.

FIG. 3C illustrates a block diagram of a portion of the example of the system illustrated in FIG. 3A. As illustrated in FIG. 3C, the fourth number of tile icons 356-16, 356-17, 356-18 are displayed in the second portion 352 of the display grid 344 and the first number of tile icons 354-1, 354-2, 354-3, 354-4, 354-5, 354-6, 354-7, . . . 354-Y are displayed in the first portion 350 of the display grid 344. Some examples of the present disclosure provide that the display grid 344 maintains a consistent size. For example, the second portion 352 of the display grid 344 displaying the fourth number of tile icons can have the same size as the second portion 352 of the display grid 344 displaying the second number of tile icons. Similarly but not illustrated, the first portion 350 of the display grid 344 displaying the third number of tile icons can have the same size as the first portion 350 of the display grid 344 displaying the third number of tile icons.

Some examples of the present disclosure provide that the touch screen 342 is coupled to an operating system. For example, the touch screen 342 can be coupled to Windows, Linux, Ubento, Android, or another other operating system.

The above specification provides a description of the method and applications, and use of the system and method of the present disclosure. Since many examples can be made without departing from the spirit and scope of the system and method of the present disclosure, this specification merely sets forth some of the many possible example configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of one or more examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the one or more examples of the present disclosure includes other applications in which the above structures and methods are used. Therefore, the scope of one or more examples of the present disclosure should be determined with reference to the appended claims, along with the full range of equivalents to which such claims are entitled.

The term “a number of” is meant to be understood as including at least one but not limited to one.

What is claimed:

1. A method for tile icon display, comprising:
retrieving a first number of unique identifiers from a first file system directory;
retrieving a second number of unique identifiers from a second file system directory;
displaying a first number of tile icons in a first portion of a display grid of a touch screen, wherein the first number of tile icons is respectively associated with one of the first number of unique identifiers; and
displaying a second number of tile icons in a second portion of the display grid of the touch screen, wherein the second number of tile icons is respectively associated with one of the second number of unique identifiers.

2. The method of claim 1, wherein the touch screen is coupled to an operating system.

3. The method of claim 1, wherein the first file system directory is a desktop directory.

4. The method of claim 3, wherein the second file system directory is a program directory.

5. The method of claim 4, wherein the program directory includes Start Menu programs.

6. A non-transitory computer-readable medium storing a set of instructions executable by a computer to cause the computer to:
retrieve a first number of unique identifiers from a first file system directory;
retrieve a second number of unique identifiers from a second file system directory;
display a first number of tile icons in a first portion of a display grid of a touch screen, wherein the first number of tile icons is respectively associated with one of the first number of unique identifiers; and
display a second number of tile icons in a second portion of the display grid of the touch screen, wherein the second number of tile icons is respectively associated with one of the second number of unique identifiers.

7. The non-transitory computer-readable medium of claim 6, wherein the set of instructions executable by a computer cause the computer to display a third number of tile icons in the first portion of the display grid of the touch screen, wherein each of the third number of tile icons is respectively associated with one of the first number of unique identifiers.

8. The non-transitory computer-readable medium of claim 6, wherein the set of instructions executable by a computer cause the computer to display a fourth number of tile icons in the second portion of the display grid of the touch screen, wherein each of the fourth number of tile icons is respectively associated with one of the second number of unique identifiers.

9. The non-transitory computer-readable medium of claim 6, wherein the set of instructions executable by a computer cause the computer to remove at least one of the first number of tile icons from the first portion of the display grid of the touch screen.

10. The non-transitory computer-readable medium of claim 6, wherein the set of instructions executable by a computer cause the computer to remove at least one of the second number of tile icons from the second portion of the display grid of the touch screen.

11. A system for tile icon display, comprising:
a processor;
a memory coupled to the processor;
wherein the processor executes instructions to:
retrieve a first number of unique identifiers from a first file system directory;
retrieve a second number of unique identifiers from a second file system directory;
display a first number of tile icons in a first portion of a display grid of a touch screen that is coupled to a operating system, wherein the first number of tile icons is respectively associated with one of the first number of unique identifiers;
display a second number of tile icons in a second portion of the display grid of the touch screen, wherein the second number of tile icons is respectively associated with one of the second number of unique identifiers;
remove at least one of the first number of tile icons from the first portion of the display grid of the touch screen; and
display a third number of tile icons in the first portion of the display grid of the touch screen, wherein each of the third number of tile icons is respectively associated with one of the first number of unique identifiers.

12. The system of claim 11, wherein the processor executes instructions to:
remove at least one of the second number of tile icons from the second portion of the display grid of the touch screen; and
display a fourth number of tile icons in the second portion of the display grid of the touch screen, wherein each of the fourth number of tile icons is respectively associated with one of the second number of unique identifiers.

13. The system of claim 12, wherein the first file system directory is a desktop directory and the second file system directory is a program directory.

14. The system of claim 11, wherein the third number of tile icons are displayed in an area of the touch screen that is equal to an area of a touch screen that displays the first number of tile icons.

15. The system of claim 14, wherein the fourth number of tile icons are displayed in an area of the touch screen that is equal to an area of the touch screen that displays the second number of tile icons.
